(19) United States
(12) Patent Application Publication
(10) Pub. No.: US 2010/0265046 A1
(43) Pub. Date: Oct. 21, 2010

(54) Induction rescue device for vehicles

(76) Inventors: Youn-Jan LIN, Taichung City (TW); Su-Ching LIN, Taichung City (TW)

Correspondence Address: BACON & THOMAS, PLLC, 625 SLATERS LANE, FOURTH FLOOR, ALEXANDRIA, VA, 22314-1176, US

(21) Appl. No.: 12/385,646

(22) Filed: Apr. 15, 2009

(51) Int. Cl. B60Q 1/00; G08B 23/00

(52) U.S. Cl. 340/425.5; 340/573.1

(57) ABSTRACT

An induction rescue device for vehicles is disclosed which comprises at least one sensing element mounted in a vehicle, where the sensing element is electrically connected to a mayday activation apparatus powered by the power supply of the vehicle. Once the vehicle is powered off, the sensing element will sense if someone is trapped in the vehicle, then actuate a mayday activation apparatus, and issue a mayday to the outside for help. And the mayday will direct at least one controlled vent to open and/or at least one coercive cooling-down apparatus to activate for circulating the air in the vehicle and to cool the temperature that the trapped passenger can survive and let outside people notice the accident in the vehicle earlier.

### BACKGROUND OF THE INVENTION

1. Field of the Invention

This invention relates generally to induction rescue device for vehicles and more specifically to one that is capable of activating a mayday activation apparatus for issuing a distress call, which makes use of sensing elements during passengers trapped in a vehicle, where the rescue device directs at least one controlled vent to open and/or at least one cooling-down apparatus to cool the temperature in the vehicle.

2. Description of the Prior Art

Kindergartens always make use of an ordinary van as the carriage vehicle for transporting children back and forth between their homes and the school. The ordinary vans may not be equipped with a rescue system. The structure of vans is probably sealed tightly for the isolation of air. And the parking lot of the carriage vehicle is most likely distant from the classroom. Once a child is missed and locked in a carriage vehicle, a loud yell or scream out of fear won't let outside know something peculiar in the vehicle. The child in fear is hardly thinking of opening the movable type of transparent glass window, nor is he/she able to open it even if he/she does think of it, which will lead to a tragedy where the rescue is hopeless.

Young children that were confined in a vehicle carelessly or purposely leading to an accidental death of dehydration caused by high temperature have happened quite many times; for instance, a young child was confined in a carriage vehicle as the penalty for being noisy executed by a kindergarten teacher in Pingtung, Taiwan on middle April 1996, and the teacher forgot about the inflicted young child still in the vehicle. Eventually, as other children got on the carriage vehicle to go home, the inflicted young child was found to have died for dehydration; on middle May 2004 and late September 2005, there were calamities happened in Taichung City, Taiwan, where the young children died for asphyxia. For each cases, the young child fell asleep and the teacher was neglectful of his absence and the driver also locked the vehicle without a final inspection; similarly, there were four calamities in Guangdong Province, China in 2007 that were caused by the negligence of the teachers and drivers; there were some similar calamities in the States in 2003, where the children were shut in the car and died for hypoxia; the same disaster happened in Fukuoka, Japan, where a two-year-old kid was shut in a carriage vehicle and died for asphyxia. Every child is a darling and treasure of his/her parents. It is miserable for the parents watch the death of their darling.

Aside from the children carriage vehicle, there are quite many other vehicles with different purposes that are likely to enclose children in it, which has to take necessary precautions to avoided the possible disaster. For instance, as young children may fall asleep and won't wake up during taking the school bus. Since they tend to incline their bodies, it is hard for them to be seen by others. The vehicles that transport children of cerebral palsy or physically disabled children or even the private sedans are reported to have shut the children as the result of negligence. There was an inattentive father who went home after he had parked and locked his car, which ridiculously forces a seven-year-old son and a five-year-old daughter die for asphyxia. It happened in Miaoli, Taiwan in 1999.

Those children or the elderly having not gotten off and shut in a vehicle are mostly falling into a deep sleep, where the standstill and quiet atmosphere in the vehicle make them to be fast asleep. Almost all the carriage vehicles are airtight in design. In addition to the suffocation of air, the inside temperature that rises impulsively due to the direct exposure to the sun sometimes reaches to the degree of 50˜60□, which makes the sleeper lose water due to the high temperature surrounding. And this symptom further leads to a state of dehydration, coma, shock or death.

Everybody knows that the disasters of children trapped in a vehicle are hardly to avoid. If there is an apparatus that helps those trapped in a vehicle to keep off high temperature for a survival firstly and simultaneously issue a mayday to the outside looking for rescue, which would substantially cut down the injury.

### SUMMARY OF THE INVENTION

Accordingly, this inventor conceived the idea of an induction rescue device for vehicles. Once a vehicle is parked and powered OFF, the induction rescue device will sense someone trapped in the vehicle, then issue a mayday to the outside for help, and open a vent and/or cool the temperature in the vehicle automatically, which helps to circulate the internal air and/or lower the temperature to make a survival.

The objective of this invention is to provide an induction rescue device for vehicles, which senses trapped passengers in a vehicle by means of a sensing element, where the rescue device is capable of activating a mayday activation apparatus for directing at least one controlled vent to appear which helps to circulate the air in the vehicle that prevents an accident.

Another objective of the present invention is to provide an induction rescue device for vehicles, which senses trapped passengers in a vehicle by means of a sensing element, where the rescue device is capable of activating a mayday activation apparatus for directing at least one cooling-down apparatus to cool the temperature in the vehicle that prevents an accident.

A further objective of the present invention is to provide an induction rescue device for vehicles, which senses trapped passengers in a vehicle by means of a sensing element, where the rescue device is capable of activating a mayday activation apparatus for issuing a distress call to the outside for being found earlier that prevents an accident.

To achieve the aforesaid objectives, an induction rescue device for vehicles is designed by this inventor, which is a sensing element set up in the vehicle, where the sensing element is electrically wired to connect to a mayday activation apparatus, and the mayday activation apparatus is powered by the power supply of the vehicle; once a vehicle is powered off, the sensing element will sense passengers trapped in the vehicle, actuate a mayday activation apparatus, and issue a mayday to the outside for help; and an effect done by the mayday activation apparatus to issue a mayday is to direct at least one controlled vent to open for circulating the inner air in the vehicle with the outside air.

This invention may be an induction rescue device for vehicles, which is a sensing element set up in the vehicle, where the sensing element is electrically wired to connect to a mayday activation apparatus, and the mayday activation apparatus is powered by the power supply of the vehicle; once a vehicle is powered off, the sensing element will sense passengers trapped in the vehicle, actuate a mayday activation apparatus, and issue a mayday to the outside for help; and an effect done by the mayday activation apparatus to issue a mayday is to direct at least one cooling-down apparatus to cool the temperature in the vehicle.

In the aforementioned invention, the effect done by the mayday activation apparatus to issue a mayday further includes the control of a sunshade apparatus for the shield of the top and the sides of the vehicle to minimize the irradiation by the sun.

This invention may be an induction rescue device for vehicles, which is a sensing element set up in the vehicle, where the sensing element is wired electrically to connect to a mayday activation apparatus, and the mayday activation apparatus is powered by the power supply of the vehicle; once a vehicle is powered off, the sensing element will sense passengers trapped in the vehicle, actuate a mayday activation apparatus, and issue a mayday to the outside world for help, to let outside people know some passengers are trapped in the vehicle.

In the aforementioned invention, the reason that the circuit is designed for having the mayday activation apparatus powered by the power supply of the vehicle is on the other hand for having the mayday activation apparatus deactivated once the vehicle is powered on; reversely, as the vehicle is powered off, then the mayday activation apparatus is activated to work.

In the aforementioned invention, the circuit for having the mayday activation apparatus powered by the power supply of the vehicle can be designed to be the manual control for the activation of the mayday activation apparatus.

In the aforementioned invention, the coercive cooling-down apparatus is one that generates physically coercive temperature dropping effect.

In the aforementioned invention, the coercive cooling-down apparatus is one that generates chemically coercive temperature dropping effect.

In the aforementioned invention, the mayday activation apparatus issues a mayday to let outside people know something wrong, which includes the effects of sounding the built-in horns or externally added horns.

In the aforementioned invention, the mayday activation apparatus issues a mayday to let outside people know something wrong, which includes the effects of lightening the built-in lights or externally added lights.

In the aforementioned invention, the mayday activation apparatus issues a mayday to let outside people know something wrong, which includes the effect of issuing a wireless signal to remote operation that generates a mayday.

### BRIEF DESCRIPTION OF THE DRAWINGS

FIG. 1 is a three-dimensional external view of the exemplary embodiment of the present invention;

FIG. 2 is a schematic diagram of the status for a setup of the exemplary embodiment of the present invention;

FIG. 3 is a schematic diagram showing the status of using a controlled window to open upward under the control by the exemplary embodiment of the present invention;

FIG. 4 is a schematic diagram showing the status of using a power window to open downward under the control by the exemplary embodiment of the present invention;

FIG. 5 is a schematic diagram showing the status of using an air conditioner under the control by the exemplary embodiment of the present invention;

FIG. 6 is a schematic diagram showing the folding of an additional mounted sunshade apparatus of the exemplary embodiment of the present invention;

FIG. 7 is a schematic diagram showing the unfolding of an additional mounted sunshade apparatus of the exemplary embodiment of the present invention; and

FIG. 8 is a flow chart of the use of the exemplary embodiment of the present invention.

### DETAILED DESCRIPTION OF THE INVENTION

To achieve the aforesaid objectives of this invention, the technique adopted and the achievable functions are detailed described with reference to the following preferred embodiments and the accompanying drawings, which would give the honorable Examiner a thorough comprehension on this invention.

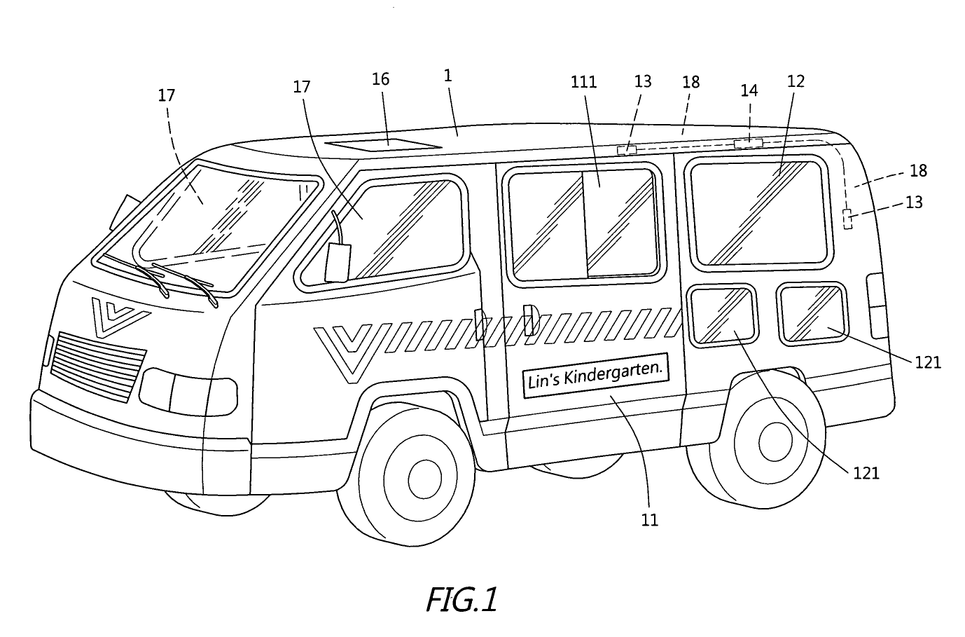

This invention is actually applied to any vehicles. For easy description sake, a children carriage vehicle (baby van 1) is selected as the exemplary embodiment. Referring to FIG. 1, the exemplary embodiment of the present invention is a baby van 1, where the rear portion of the baby van 1 is usually refitted for seating children, and both sides of the vehicle are equipped with movable doors 11. Movable type of transparent glass windows 111 and sealed type of transparent glass windows 12 are set up on the doors 11 and on appropriate locations at the back of the sides of the vehicle respectively; a sensing element 13 and a mayday activation apparatus 14 and the connected wires in between are set up behind the sheet metal 18 of the vehicle. A plurality of transparent side windows 121 (glass, acrylic or the like material that are transparent in nature) are optionally mounted below the sealed type of transparent glass windows 12, which enable young children to view outside during emergency which would help to get rescue by the outside people.

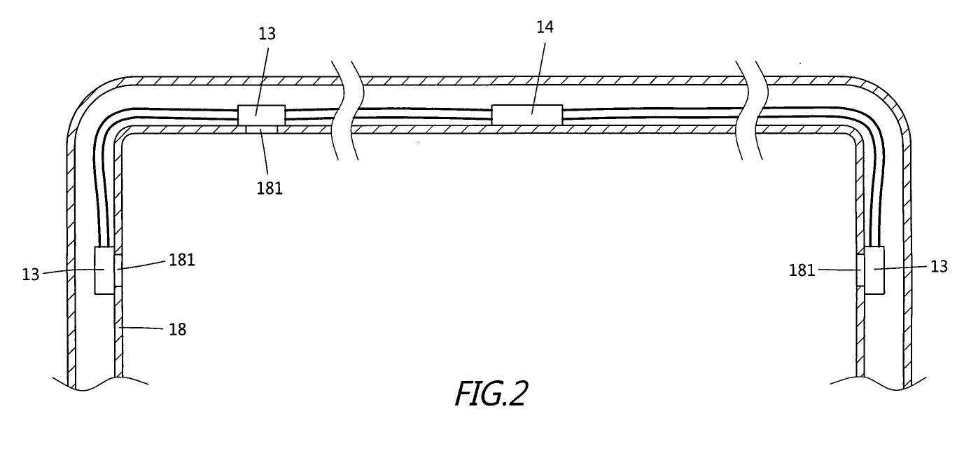

It is appropriate for the sensing elements 13 to be mounted inside the sheet metals 18 of the side walls, the ceiling (shown in FIG. 2) or the floor of the baby van 1. There is no constraint to where to have the element mount, and the more the better. The only concern is to have the sensing side of the sensing element 13 face toward the through hole 181 of the sheet metal 18 and point to the location of a passenger; the sensing element 13 is electrically joined with the mayday activation apparatus 14, so that the mayday activation apparatus 14 is also set up behind the sheet metal or any other hidden places, and no constraint for locating it; the place for lodging the sensing element 13, the mayday activation apparatus 14 and the electric wires connected in between mounted inside the sheet metal 18 is merely an exemplary embodiment, the scope of the claim of this invention is not limited therewith. Otherwise, if the sensing element 13, the mayday activation apparatus 14 and the electric wires connected in between are placed external to the sheet metal 18, it is absolutely within the scope of the claim of this invention. However, the external mounting type of layout has made the entire system expose to the danger of being torn down by the passengers or any unexpected pulling or dragging.

The sensing element 13 is one that may have any mode of sensing functions, for instance: the sensing element 13 is one that may be sensible to sound. Once any sound generated by the trapped passengers is sensed by the sound sensors, the induction is activated; the sensing element 13 is one that may be sensible to vibration. Once any beatings to windows or side walls of the vehicle by the trapped passengers are sensed by the vibration sensors, the induction is activated; again, the sensing element 13 is one that may be sensible to a push or a pull. There are buttons set up in the vehicle for pulling or pushing. Once a push or a pull to the button by the trapped passengers that will be sensed by the push or pull sensors, the induction is activated; or, the sensing element 13 may be one that features one of the following sensing modes: sensible to the pressure (where the pressure sensors are mounted at the floor for sensing the pressure from the feet), sensible to the concentration of carbon dioxide (the sensor is mounted in the vehicle, once it senses the rise of the concentration of carbon dioxide, the induction is activated), sensible to infrared rays (emits infrared rays in the vehicle, and the induction is activated if any of the passengers is being irradiated), sensible to supersonic waves (emits supersonic waves in the vehicle, and the induction is activated if any of the passengers is being irradiated), sensible to microwaves (radiates microwaves in the vehicle, and the induction is activated if any of the passengers is being irradiated), sensible to air pressure (where the air pressure sensors are mounted in the vehicle and the induction is activated if any change of the air pressure is sensed). The sensing elements 13 of this invention may feature any one of the above modes, or it could be the mixed type of more than two modes.

The mayday activation apparatus 14 is powered by the power supply of the baby van 1, where the operation of power supply is designed as the moment the baby van 1 is powered on, the mayday activation apparatus 14 is cut off, which means the mayday activation apparatus 14 won't work at this moment; reversely, as the baby van 1 is cut off, the power will be connected automatically to the mayday activation apparatus 14 to activate it, which is a handy mode for the operation; or, it could be a manual operating mode (which includes direct control by a switch and remote control by a remote controller) to replace the above automatic mode, which could achieve the same function.

The combination of the mayday activation apparatus 14, the sensing elements 13 and the electric wires connected in between is actually a circuit device, where the mayday activation apparatus 14 will issue a mayday after it receives a signal from the sensing elements 13; and the following effects usually accompany the mayday:
1. The effect that the mayday activation apparatus issues a mayday is to direct at least one “controlled vent” to open which helps to circulate the outside air into the vehicle through the vent to release the pain of sultriness readily, for at least keeping a survival.
2. The effect that the mayday activation apparatus issues a mayday is to direct at least one “cooling-down apparatus” to activate which cools the temperature in the vehicle that helps to release the pain of sultriness readily, at least keeping a survival.
3. The effect that the mayday activation apparatus issues a mayday is to let outside people know that there are passengers trapped in the vehicle, for instance: the mayday could direct to sound the build-in horns or externally added horns, and/or turn the lights on to send out flash light, or generate a wireless signal to alert remote personnel (for instance the teachers in the office) to notice that children are trapped in the vehicle.

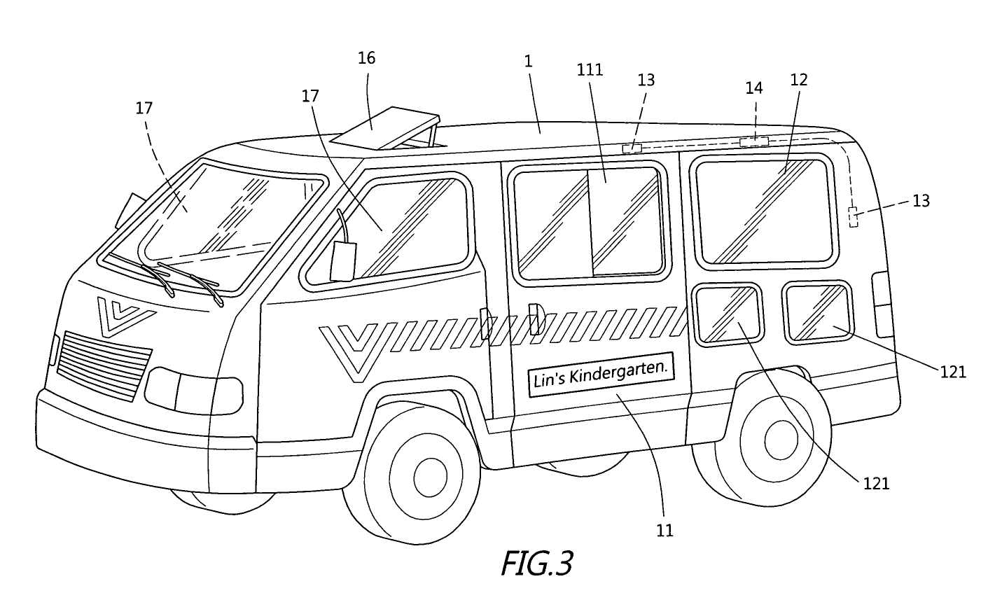

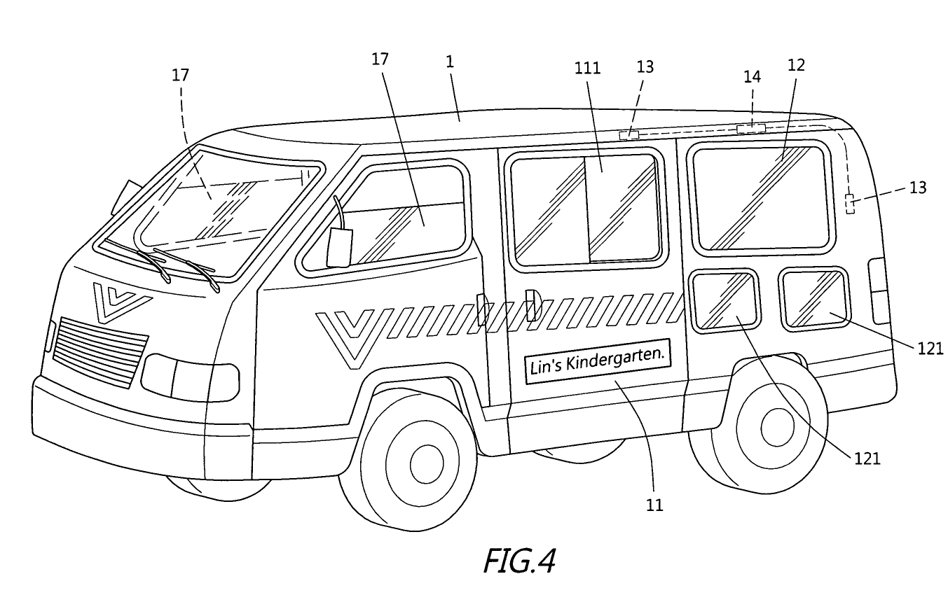

The aforesaid “controlled vent” means whatever the vents may appear in the vehicle that are response to the actuation of the mayday issued by the mayday activation apparatus 14 are considered to be embraced. For instance, as the mayday activation apparatus 14 receives the signal from the sensing element 13, its circuit device will generate a mayday to further direct a controlled window 16 to open upward (shown in FIG. 3); the controlled window 16 is better to be mounted at the top side (shown in FIGS. 1 & 3) of the baby van 1 (not big enough to lure the children to climb out), which won't exclude the possibility to mount at any location in the vehicle; the controlled window 16 is in the close state by default (it works either by manual operating or by automatic operating); once the mayday activation apparatus 14 receives the signal from the sensing element 13, the controlled window 16 will open upward (shown in FIG. 3), subject to the function of the electric circuit and the pushing force through the parts (for instance: hydraulic cylinder), which enables air to flow in the vehicle. Accordingly, the controlled window 16 is an exemplary embodiment of the “controlled vent”. Aside from the controlled window 16 realizing the “controlled vent” shown in FIG. 3, there are quite many different exemplary embodiments, for, instance, the one shown in FIG. 4, where the mayday activation apparatus 14 is designed to direct the built-in power windows 17 of the vehicle to lower for a certain distance that could circulate with outside air, which would release the pain of sultriness readily and keep a survival. The built-in power windows 17 of the vehicle directed by the mayday activation apparatus 14 is an exemplary embodiment of the “controlled vent”.

The description of at least one “controlled vent” to appear means that there could be two or more controlled vents to appear. For instance, a simultaneous control of a controlled window 16 to open upward and a power window to open downward will not only boost the air circulation but lift the flow rate due to the process of convection, which enables the trapped passengers to have much more air.

The “coercive cooling-down apparatus” means whatever the coercive cooling-down devices may appear in the vehicle as the response to the actuation of the mayday issued by the mayday activation apparatus 14 are considered to be embraced. For instance, if air conditioners and electric fans mounted in the vehicle are activated by the mayday of the mayday activation apparatus 14, which means the air conditioners and the electric fans are the exemplary embodiments of the coercive cooling-down apparatus.

Any device mounted in the vehicle that is able to cool the temperature coercively is therefore considered to be embraced by the coercive cooling-down apparatus of this invention; for instance, under the control of the mayday of the mayday activation apparatus 14, a device that is used to cool the temperature in the vehicle through a chemical approach, and the device is considered to be embraced by the coercive cooling-down apparatus of this invention. Furthermore, the coercive cooling-down apparatus of this invention comprises the devices that feature cooling the temperature through a physical approach and the devices that feature cooling the temperature through a chemical approach.

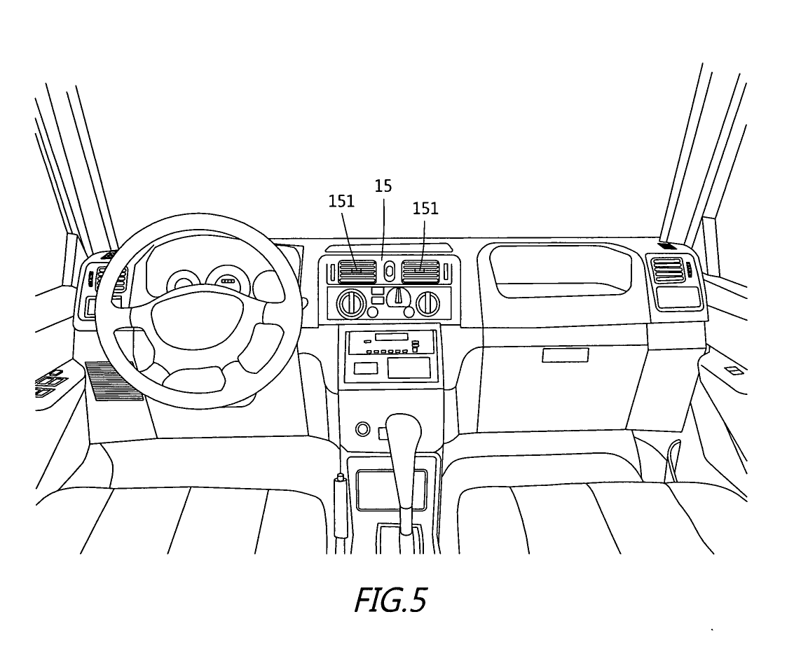

The air conditioner mounted in a vehicle is used as the exemplary embodiment of the coercive cooling-down apparatus, shown in FIG. 5, where the built-in air conditioner of the vehicle is the realization of the coercive cooling-down apparatus of this invention, and the cool air flows out through the built-in vents 151. However, this application calls for a modification to the circuits of the air conditioner 15 to enable its compressor running during the vehicle is powered on, which simply makes use of the air conditioner; additionally, once the sensing element 13 senses someone is trapped in the vehicle, the air conditioner is activated to respond to the mayday of the mayday activation apparatus 14, where the air conditioner has to work during the vehicle is powered off.

The air conditioner of a vehicle is used as an exemplary embodiment of the coercive cooling-down apparatus. Aside from the built-in air conditioner of the vehicle shown in FIG. 5 is to be used for this application, the additionally mounted air conditioners are also to be used, where its running is responsive to the actuation of the mayday activation apparatus 14. If the fans in the vehicle are regarded as exemplary embodiments of the coercive cooling-down apparatus, the additionally mounted fans are in the majority. No matter they are additionally mounted air conditioners or fans for realizing the coercive cooling-down apparatus, the electric power may be supplied by the power supply of the vehicle, or by the additional mounted power supply. The actuation of the coercive cooling-down apparatus may have an extra mode which is sensible to the temperature. As the temperature exceeds a predetermined value (say 30□, for instance), the coercive cooling-down apparatus is activated, which avoids unnecessary wastes.

The description of at least one “coercive cooling-down apparatus” to act means it could be two or more coercive cooling-down apparatus to act. For instance, a simultaneous actuation of an originally built-in air conditioner 15 and an additionally mounted air conditioner, a simultaneous actuation of an originally built-in air conditioner 15 and an additionally mounted fan, or three coercive cooling-down apparatus act together: a simultaneous actuation of an originally build-in air conditioner 15, an additionally mounted air conditioner and an additionally mounted fan; or, a further option can be more than one additionally mounted air conditioner or more than one additionally mounted fan. Multiple coercive cooling-down apparatuses help to lower the temperature promptly, which is designed to cope with damn hot situations.

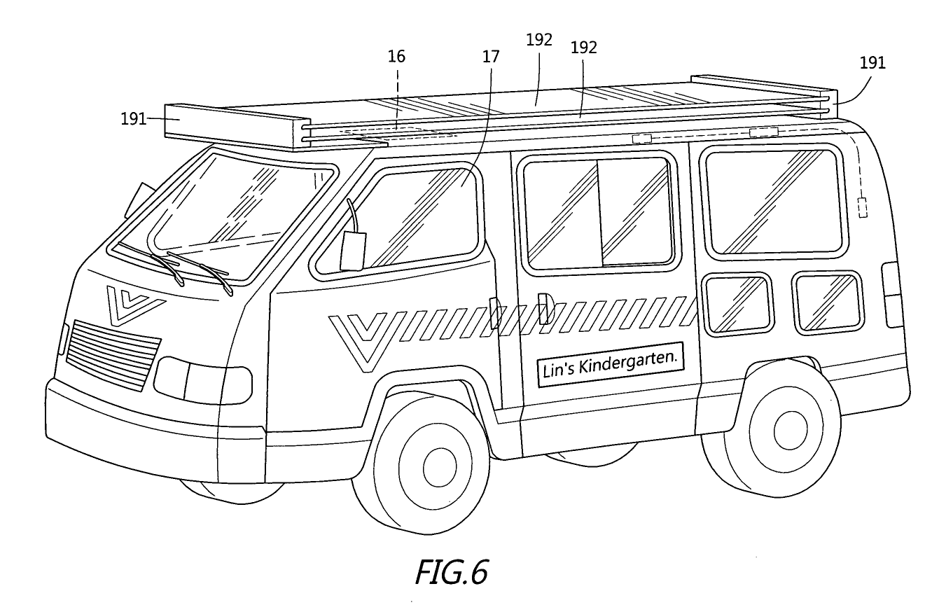

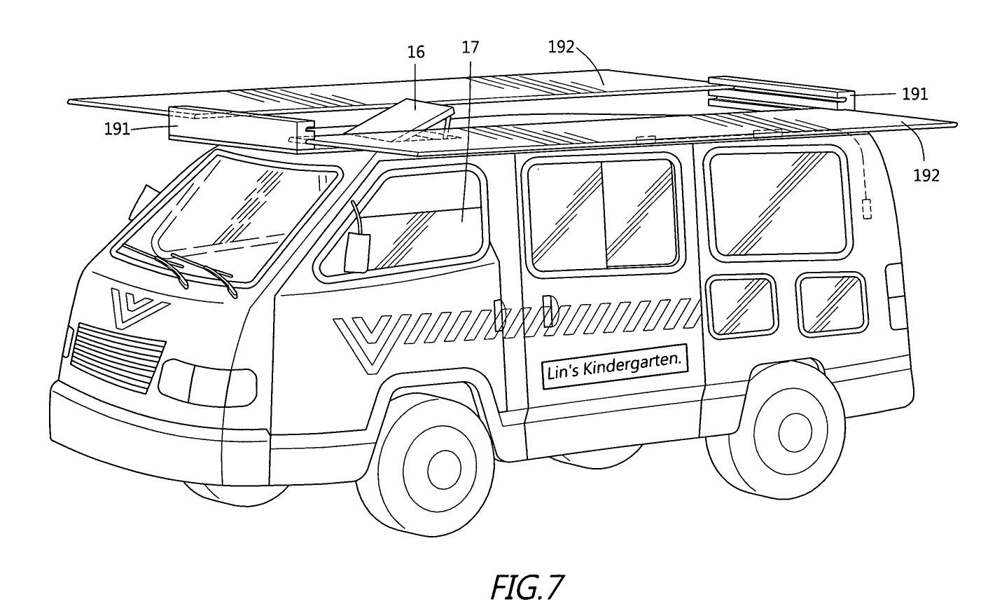

The effect that the mayday activation apparatus 14 issues a mayday is to direct at least one “controlled vent” to open, shown in FIGS. 3 & 4, and/or to direct at least one “cooling-down apparatus” to activate, shown in FIG. 5, it may further control a sunshade device to activate, shown in FIG. 6. Board holders 191 are mounted on top, where sunshade boards 192 are placed in between. The sunshade boards 192 are collected by electric power into their lodgment at ordinary times, while the sunshade boards 192 are extended toward both lateral sides by the actuation of the mayday activation apparatus 14, shown in FIG. 7, to shade the top and the laterals of the vehicle from exceedingly exposure to the sun; meanwhile, the controlled windows 16 and/or the power windows 17 are activated to open, and/or the air conditioner is activated to run.

The mayday issued by the mayday activation apparatus 14 is not only to direct at least one “controlled vent” to open and/or to direct at least one “cooling-down apparatus” to activate, but it may further let outside people know that someone is trapped inside by issuing distress-alert signals such as activating: the built-in horns and/or lights, or externally added horns and/or the lights to catch outside people's notice; besides, the mayday activation apparatus 14 may generate a wireless signal for the remote activation of a mayday signal, that is, the mayday activation apparatus 14 generates a wireless signal, which is received by a receiver in a remote kindergarten office that proceeds to control the buzzers or lights to sound or flash to alert the office staff to take action.

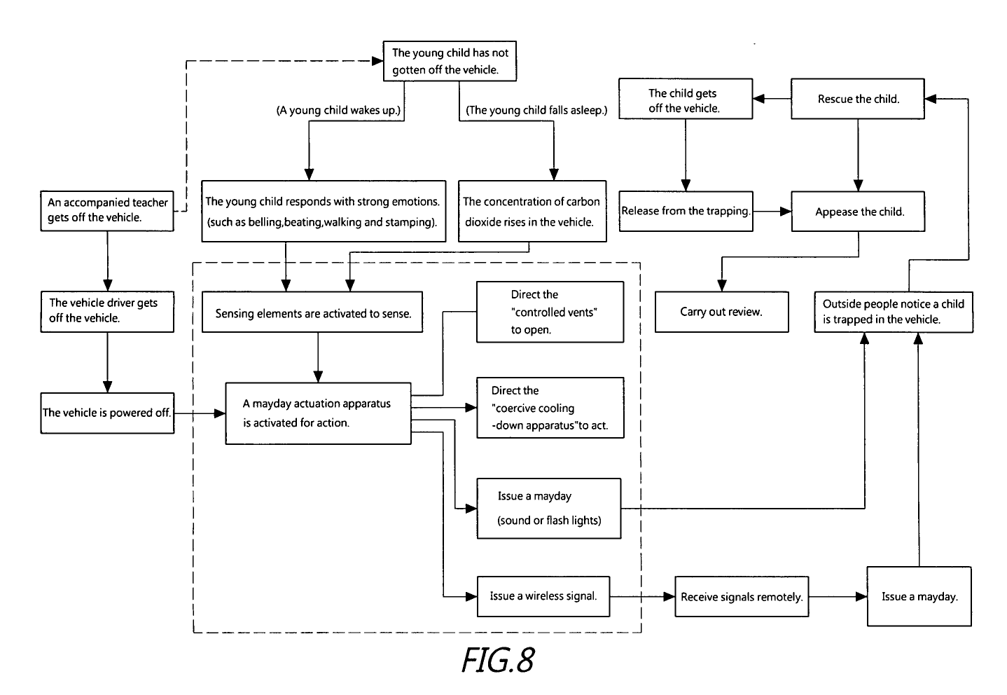

The use of this invention is in the flow chart of FIG. 8. Once there is a young child shut in the baby van 1, where all the car doors are locked. The child most likely may react with strong emotions: crying, yelling, beating, walking and stamping. Even if the child falls asleep without showing those emotions, the concentration of carbon dioxide in the vehicle will rise gradually. No matter what the situation may be, once a sensing element 13 in the vehicle senses someone is trapped, the mayday activation apparatus 14 will be activated to direct at least one controlled vent (for instance: controlled window 16 and/or car window 17) to open, to have air circulating in the vehicle, and/or to direct at least one cooling-down apparatus to activate, to lower the inside high temperature, which assures the survival of the child, and activates sound, light and remote activation of a mayday to catch outside people's notice for taking action that may avoid a possible disaster.

Accordingly, the disclosed techniques of this invention is indeed able to effectively avoid someone to be left carelessly in a vehicle that would lead to a disaster, and can accomplish the expected objective and function, which is construed as compliant to the requirements of a utility patent, thereby filing the present application herein subject to the patent law. However, the aforesaid are simply the exemplified embodiments of the present invention, which are not intended to limit the scope of the claim of this invention. Any equivalent embodiments or modifications without departing from the spirit and scope of the present invention are therefore intended to be embraced.

What is claimed is:

1. An induction rescue device for vehicles, which is a sensing element set up in the vehicle, where the sensing element is electrically connected to a mayday activation apparatus, and the mayday activation apparatus being powered by the power supply of the vehicle; once the vehicle is powered off, the sensing element sensing if someone is trapped in the vehicle, then actuating a mayday activation apparatus, and issuing a mayday to the outside for help; and an effect done by the mayday activation apparatus to issue a mayday being to direct at least one controlled vent to open for circulating the air in the vehicle with the outside.

2. An induction rescue device for vehicles as in claim 1 wherein the electric circuit of the mayday activation apparatus powered by the power supply of the vehicle is designed for having the mayday activation apparatus deactivated once the vehicle is powered on; and the mayday activation apparatus being activated to run once the vehicle is powered off.

3. An induction rescue device for vehicles as in claim 1 wherein the electric circuit of the mayday activation apparatus powered by the power supply of the vehicle may be designed for manual control of the activation of the mayday activation apparatus.

4. An induction rescue device for vehicles as in claim 1 wherein the effect done by the mayday activation apparatus to issue a mayday further includes the control of a sunshade apparatus for the shield of the top and the sides of the vehicle to minimize the irradiation by the sun.

5. An induction rescue device for vehicles, which is a sensing element set up in the vehicle, where the sensing element is electrically connected to a mayday activation apparatus, and the mayday activation apparatus being powered by the power supply of the vehicle; once the vehicle is powered off, the sensing element sensing if someone is trapped in the vehicle, then actuating a mayday activation apparatus, and issuing a mayday to the outside for help; and an effect done by the mayday activation apparatus to issue a mayday being to direct at least one coercive cooling-down apparatus to act for cooling the temperature in the vehicle.

6. An induction rescue device for vehicles as in claim 5 wherein the electric circuit of the mayday activation apparatus powered by the power supply of the vehicle is designed for having the mayday activation apparatus deactivated once the vehicle is powered on; and the mayday activation apparatus being activated to run as the vehicle being powered off.

7. An induction rescue device for vehicles as in claim 5 wherein the electric circuit of the mayday activation apparatus powered by the power supply of the vehicle may be designed for manual control of the activation of the mayday activation apparatus.

8. An induction rescue device for vehicles as in claim 5 wherein the coercive cooling-down apparatus may generate physically coercive temperature dropping effect.

9. An induction rescue device for vehicles as in claim 5 wherein the coercive cooling-down apparatus may generate chemically coercive temperature dropping effect.

10. An induction rescue device for vehicles as in claim 5 wherein the effect done by the mayday activation apparatus to issue a mayday further includes the control of a sunshade apparatus for the shield of the top and the sides of the vehicle to minimize the irradiation by the sun.

11. An induction rescue device for vehicles, which is a sensing element set up in the vehicle, where the sensing element is electrically connected to a mayday activation apparatus, and the mayday activation apparatus being powered by the power supply of the vehicle; once the vehicle is powered off, the sensing element sensing if someone is trapped in the vehicle, then actuating a mayday activation apparatus, and issuing a mayday to the outside for help, to let outside people know some passengers being trapped in the vehicle.

12. An induction rescue device for vehicles as in claim 11 wherein the electric circuit of the mayday activation apparatus powered by the power supply of the vehicle is designed for having the mayday activation apparatus deactivated once the vehicle is powered on; and the mayday activation apparatus being activated to run as the vehicle being powered off.

13. An induction rescue device for vehicles as in claim 11 wherein the electric circuit of the mayday activation apparatus powered by the power supply of the vehicle may be designed for manual control of the activation of the mayday activation apparatus.

14. An induction rescue device for vehicles as in claim 11 wherein the mayday activation apparatus issues a mayday to let outside people know something wrong in the vehicle, including to sound the built-in horns or externally added horns.

15. An induction rescue device for vehicles as in claim 11 wherein the mayday activation apparatus issues a mayday to let outside people know something wrong in the vehicle, including to lighten the built-in lights or externally added lights.

16. An induction rescue device for vehicles as in claim 11 wherein the mayday activation apparatus issues a mayday to let outside people know something wrong in the vehicle, including issuing a wireless signal to remote operation that generates a mayday.
